(19) United States
(12) Patent Application Publication
(10) Pub. No.: US 2026/0125316 A1
(43) Pub. Date: May 7, 2026

(54) BIO-BASED BINDER SYSTEMS

(71) Applicant: CARGILL, INCORPORATED, Wayzata, MN (US)

(72) Inventors: Ryan L. Flynn, Plymouth, MN (US); Todd L. Kurth, Maple Grove, MN (US)

(73) Assignee: CARGILL, INCORPORATED, Wayzata, MN (US)

(21) Appl. No.: 19/481,067

(22) PCT Filed: Apr. 10, 2024
(86) PCT No.: PCT/US2024/023777

§ 371 Date: Nov. 3, 2025

Related U.S. Application Data
(60) Provisional application No. 63/464,346, filed on May 5, 2023.

(51) Int. Cl. C03C 25/255; C03C 25/1095; C03C 25/50

(52) U.S. Cl. CPC C03C 25/255; C03C 25/1095; C03C 25/50

(57) ABSTRACT

A method for dedusting a fibrous insulation product using an epoxidized vegetable oil, such as epoxidized soybean oil, having a iodine value less than 10 cg I₂ per gram and an oxidation exotherm by pressure differential scanning calorimeter of less than 500 joules/gram at an oven temperature of 130° C. and an oxygen inlet pressure of 500 PSIG. The fibrous insulation product typically is made with a binder composition that is applied to mineral fibers in addition to the epoxidized vegetable oil prior to the binder composition being cured.

### CROSS-REFERENCE TO RELATED APPLICATIONS

This application claims the benefit of U.S. Provisional Application No. 63/464,346, filed May 5, 2023, which is incorporated by reference herein in its entirety.

### TECHNICAL FIELD AND INDUSTRIAL APPLICABILITY OF THE INVENTION

The present invention relates methods of using epoxidized plant-based oils (such as epoxidized soybean oil (ESO)) for reducing dust emanating from a manufacturing system utilized to make mineral fiber insulation (such as fiberglass insulation and stone wool insulation).

### BACKGROUND OF THE INVENTION

Conventional fibers are useful in a variety of applications including reinforcements, textiles, and acoustical and thermal insulation materials. Although mineral fibers (e.g., glass fibers and fibers made from stone) are typically used in insulation products, depending on the particular application, organic fibers such as polypropylene, polyester, and multi-component fibers may be used in combination with mineral fibers in forming the insulation product.

Fibrous insulation is typically manufactured by fiberizing a molten composition of polymer, glass, or other mineral (e.g., stone) and spinning fine fibers from a fiberizing apparatus, such as a rotating spinner. To form an insulation product, fibers produced by the rotating spinner are drawn downwardly from the spinner towards a conveyor by a blower. As the fibers move downward, a binder composition is sprayed onto the fibers and the fibers are collected into a high loft, continuous blanket on the conveyor. The binder composition, once cured, gives the insulation product resiliency for recovery after packaging and provides stiffness and handleability so that the insulation product can be handled and applied as needed in the insulation cavities of buildings. The cured binder composition also provides protection to the fibers from inter-filament abrasion and promotes compatibility between the individual fibers.

During the formation of fiberglass insulation (or stone wool insulation), dust can be liberated by the process. A dedust fluid is often applied to the glass fibers during the process to reduce this dust. Mineral-oil based fluids and vegetable-oil based fluids are often utilized as dedust fluids.

Mineral-oil based fluids tend to smoke or ignite in the high temperatures utilized to cure the binder composition.

Vegetable-oil based dedust fluids have a lower potential to smoke or ignite than mineral-oil based fluids. However, conventional vegetable-oil based fluids used as dedust fluids do have a limited amount of unsaturation, which can oxidize when exposed to high temperatures in the presence of an oxidizing agent.

The blanket containing the binder-coated fibers is passed through a curing oven and the binder is cured to set the blanket to a desired thickness. After the binder has cured, the fiber insulation may be cut into lengths to form individual insulation products, and the insulation products may be packaged for shipping to customer locations. One typical insulation product produced is an insulation batt or blanket, which is suitable for use as wall insulation in residential dwellings or as insulation in the attic and floor insulation cavities in buildings.

### SUMMARY OF THE INVENTION

The inventors have surprisingly discovered that fully epoxidized soybean oil (ESO) may be advantageously used as a dedust oil for mineral wool and fiberglass production facilities. The epoxidized soybean oil should have (i) an iodine value of less than 10 cg I₂ per gram, (ii) a viscosity of from 120 to 250 cSt at 40° C., (iii) an AV of less than 1 mg KOH/g, (iv) a Cleveland Open Cup Flash point of at least 280° C., (v) an oxirane content of at least 4.5 wt %, and (vi) an oxidation exotherm by pressure differential scanning calorimeter of less than 500 joules/gram at an oven temperature of 130° C. and an oxygen inlet pressure of 500 PSIG. An epoxidized soybean oil meeting the above criteria will have a flash point high enough to not ignite at the high temperatures utilized for curing the binder system when manufacturing fibrous insulation products, it has a sufficient viscosity for those high temperatures, and the ESO's low unsaturation (as shown by the low iodine value) will minimize any tendency for it to oxidize during the process of making the fibrous insulation product.

The dedust composition effectively reduces the dust generated during the process of making the fibrous insulation product, and also reduces any potential oxidation that could occur with the dedust composition compared to conventional dedust fluids. Examples of fibrous insulation product made according to the method include fiberglass insulation and mineral wool.

In some aspects, the epoxidized soybean oil has a pour point of less than 25° C., typically less than 20° C., and preferably 10° C. or less (for from about 0° C. to 10° C.). Having this low a pour point, will assist the epoxidized soybean oil in trapping dust that may be generated by the fibrous insulation product during storage, shipping and handling.

The foregoing and other objects, features, and advantages of the invention will appear more fully hereinafter from a consideration of the detailed description that follows. It is to be expressly understood, however, that the drawings are for illustrative purposes and are not to be construed as defining the limits of the invention.

### BRIEF DESCRIPTION OF THE DRAWINGS

The advantages of this invention will be apparent upon consideration of the following detailed disclosure of the invention, especially when taken in conjunction with the accompanying drawings wherein:

FIG. 1 is a schematic illustration of the formation of a faced insulation product made using the method described herein; and

FIG. 2 is a schematic illustration of the formation of a fiberglass insulation product with the method described herein where the insulation product does not contain a facing material.

### DETAILED DESCRIPTION OF THE INVENTION

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are described herein. All references cited herein, including published or corresponding U.S. or foreign patent applications, issued U.S. or foreign patents, and any other references, are each incorporated by reference in their entireties, including all data, tables, figures, and text presented in the cited references, unless indicated otherwise.

In the drawings, the thickness of the lines, layers, and regions may be exaggerated for clarity. It will be understood that when an element such as a layer, region, substrate, or panel is referred to as being “on” another element, it can be directly on the other element or intervening elements may also be present. Also, when an element is referred to as being “adjacent” to another element, the element may be directly adjacent to the other element or intervening elements may be present. The terms “top”, “bottom”, “side”, and the like are used herein for the purpose of explanation only. Like numbers found throughout the figures denote like elements.

“Flash Point” or “Flash Point Temperature” is a measure of the minimum temperature at which a material will initially flash with a brief flame. It is measured according to the method of ASTM D-92 using a Cleveland Open Cup and is reported in degrees Celsius (° C.).

“Pour Point” or “Pour Point Temperature” is a measure of the lowest temperature at which a fluid will flow. It is measured according to the method of ASTM D-97 and is reported in degrees Celsius (° C.).

“Iodine Value” (IV) is defined as the number of grams of iodine that will react with 100 grams of material being measured. Iodine value is a measure of the unsaturation (carbon-carbon double bonds and carbon-carbon triple bonds) present in a material. Iodine Value is reported in units of grams iodine (I₂) per 100 grams (or alternatively centigrams iodine (I₂) per gram) material and is determined using the procedure of AOCS Cd Id-92.

“Acid Value” (AV) is a measure of the residual hydronium groups present in a compound and is reported in units of mg KOH/gram material. The acid number is measured according to the method of AOCS Cd 3d-63.

“Oxirane” content is a measure of the epoxide content of a vegetable oil, such as epoxidized soybean oil. Oxirane content is measured according to the method of ASTM D1652 and is reported as weight percent (or sometimes percent) of epoxide in the material.

In some aspects, the present invention relates to environmentally friendly, bio-based binder systems useful for the formation of fibrous insulation products (e.g., fiberglass insulation and stone wool insulation). Examples of the usable binder compositions include, but are not limited to, binder systems disclosed herein. Preferably, the binder compositions comprise aqueous curable binder compositions, which are utilized together with the dedust composition. The aqueous curable binder composition and dedust composition may be applied to the fibers to be bound (e.g., fiberglass) simultaneously using the same application method or separately. Typically, they are applied concurrently, with the dedust composition being in the form of an emulsion (typically an oil-in-water emulsion) that is blended with the aqueous binder composition so that they can be applied together.

### Binder Compositions

A variety of binder compositions can be utilized in the current method. Examples of binder compositions that can be utilized include, but are not limited to, the following: phenyl formaldehyde-based binder compositions, acrylic acid-based binder compositions, polyacrylic acid-based binder compositions, binder compositions comprising carbohydrates (e.g., polyols, starches, and polycarboxylic acid) and crosslinking agents (in some aspects, binder compositions comprising polycarboxylic acid crosslinking agents and carbohydrates are preferred), binder compositions based on Maillard reactions (amine containing materials reacting with aldehyde and ketone groups as contained in compounds such as starch, starch derivatives, saccharides, and polysaccharide). Examples of binder compositions based on Maillard reactions are disclosed in U.S. Pat. No. 8,114,210 B2, granted Feb. 14, 2012 to Hampson et al. entitled “Binders” and U.S. Pat. No. 9,434,854 B2 granted Sep. 6, 2016 to Swift et al. entitled “Binders And Materials Made Therefrom”, both of which are hereby incorporated by referenced for their teachings regarding such binder compositions.

Additional examples of binder compositions usable with the current invention including, but not limited to: U.S. Pat. No. 10,988,642 B2, granted Apr. 27, 2021 to Alavi et al. entitled “Starch And Carboxylic Acid Binder Compositions And Articles Made Therefrom”; U.S. Pat. No. 9,034,952 B2 granted May 19, 2015 to Shooshtari et al. entitled “Reduced Salt Precipitation In Carbohydrate Containing Binder Compositions”; U.S. Pat. No. 8,552,140 B2 granted Oct. 8, 2013 to Swift entitled “Composite Maillard-Resole Binders”; U.S. Pat. No. 10,208,414 B2 granted Feb. 19, 2019 to Lester et al. entitled “Soy Protein And Carbohydrate Containing Binder Composition”; U.S. Pat. No. 10,550,294 B2 granted Feb. 4, 2020 to Lochel, Jr. et al. entitled “Bio-Based Binder Systems”; U.S. Pat. No. 10,030,177 B2 granted Jul. 24, 2018 to Lochel, Jr. et al. entitled “Bio-Based Binder System”; and U.S. Pat. No. 9,546,263 B2 granted Jan. 17, 2017 to Hawkins et al. entitled Bio-Based Binders For Insulation And Non-Woven Mats; all of which are hereby incorporated by reference for their teaching regarding binder compositions.

The binder system also may additionally include one or more of a coupling agent, a moisture resistant agent, a catalyst, an inorganic acid or base, and/or an organic acid or base.

At low LOIs, the binder typically has a light (e.g., white or tan) color after it has been cured. When utilized in the manufacture of fiberglass insulation, this will result in a product that can be readily died or colored.

Preferably, the binder composition/system is free of added formaldehyde.

### Aqueous Curable Binder Systems:

Aqueous curable binder system and binder compositions based on a carbohydrate with a crosslinking agent in some instances are preferred due to their ease of use and the fact that they do not emit formaldehyde as some binder compositions. Typically, for these type of binder compositions, the carbohydrate and crosslinking agent are dissolved in water prior to being applied to the fibers (e.g., mineral fibers, such as glass fibers). The water disperses (and/or dissolves) the active solids for application onto the reinforcement fibers. Water typically is added in an amount sufficient to dilute the aqueous binder composition to a viscosity that is suitable for its application to the mineral fibers and to achieve a desired solids content on the fibers. In particular, the binder composition may contain water in an amount from about 50% to about 98.0% by weight of the total solids in the binder composition.

The binder composition may be made by dissolving or dispersing the crosslinking agent in water to form a mixture. Next, the carbohydrate may be mixed with the crosslinking agent in the mixture to form the binder composition.

After the binder composition is applied, it is heated to cause the binder composition to react. For example, an aqueous binder system comprising a crosslinking agent and carbohydrate will react with one another when the aqueous binder system is heated. The reaction that occurs when the binder composition is heated is referred to as “curing” the binder composition. The resulting reaction product from the heating and reaction of the binder composition is referred to as the “cured” binder composition. When the binder composition is an aqueous binder system comprising a crosslinking agent and a carbohydrate, the resulting cured binder composition typically is mainly comprised of polyesters that result from the reaction of the acid groups of the crosslinking agent with the alcohol groups of the carbohydrate. The polyesters that are formed (and other reaction products formed during the curing of other types of binder compositions) typically form crosslinked network polymers that bind the fibers to one another. When the curing reaction generates water, the water is removed from the binder composition and the fibrous insulation product to promote the complete curing of the binder composition.

An example of an aqueous binder composition/system that may be used is set forth in Table 1. The solids shown in Table 1 are dissolved (and/or suspended (preferably dissolved)) in water to provide a binder composition that can readily be applied to the fibers (e.g., glass fibers or stone wool fibers).

TABLE 1

| | % By Weight |
|---|---|
| Component | of Total Solids |
| Carbohydrate | 30-95 |
| Crosslinking Agent | 1-40 |

In some aspects, an aqueous curable binder system may also include glycerol, polyglycerol, the reaction product of glycerol or polyglycerol and polycarboxylic acid, such as citric acid, or mixtures thereof. The glycerol is believed may even out the curing reaction of a binder system comprised of other carbohydrates and cross-linking agents. Thereby, easing the manufacture of the fibrous insulation product. If utilized, the glycerol, polyglycerol and reaction product of glycerol or polyglycerol and polycarboxylic acid are comprise less than 10 wt % of the overall dry weight of the aqueous binder composition, preferably less than 5 wt % and in some instance less than 3 wt % of the overall dry weight of the aqueous binder composition. Preferably, glycerol is utilized due to its ready availability and cost.

### A) The Carbohydrate

When a carbohydrate and crosslinking agent are utilized in an aqueous binder system, the binder composition typically includes at least one carbohydrate that is from natural and renewable resources. For instance, the carbohydrate may be derived from plant sources such as legumes, maize, corn, waxy corn, sugar cane, milo, white milo, potatoes, sweet potatoes, tapioca, rice, waxy rice, peas, sago, wheat, oat, barley, rye, amaranth, and/or cassava, as well as other plants that have a high starch content. The carbohydrate may also be derived from crude starch or cellulose-containing products derived from plants that contain residues of proteins, polypeptides, lipids, and low molecular weight carbohydrates. The carbohydrate may be selected from monosaccharides (e.g., xylose, glucose, and fructose), disaccharides (e.g., sucrose, maltose, and lactose), oligosaccharides (e.g., glucose syrup and fructose syrup), and polysaccharides and water-soluble polysaccharides (e.g., pectin, dextrin, maltodextrin, starch, modified starch, and starch derivatives). The carbohydrate may also include one or more polyol as described in U.S. Pat. No. 11,136,451 B2 granted Oct. 5, 2021 to Zhang et al. entitled “Aqueous Binder Composition” (that are used together with cross-linking agents described therein).

In one preferred aspect, the carbohydrate is a breakdown product of starch and typically has a number average molecular weight from about 1,000 to about 8,000. In some preferred aspects, the carbohydrate comprises a maltodextrin having a dextrose equivalent (DE) number from 2 to 20, from 7 to 11, or from 9 to 14.

The carbohydrates and crosslinking agent beneficially result in an aqueous binder composition having a low viscosity that reacts at moderate temperatures (e.g., 80-250° C.). The low viscosity enables the aqueous binder composition to be more readily applied to fibers utilizing conventional equipment. In exemplary embodiments, the viscosity of the carbohydrate may be lower than 500 cps at 25° C. when in a 50% aqueous solution. The use of a carbohydrate in the aqueous curable binder composition is advantageous in that carbohydrates are readily available or easily obtainable and are low in cost. In at least one exemplary embodiment, the carbohydrate is a water-soluble polysaccharide such as maltodextrin having a dextrose equivalent (DE) number from 2 to 20.

The carbohydrate may be present in the binder composition in an amount from about 30% to about 95% by weight of the total solids in the binder composition, from about 40% to about 80% by weight, or from about 50% to about 70% by weight. As used herein, % by weight indicates % by weight of the total solids in the binder composition.

### B) The Crosslinking Agent

In addition to a carbohydrate, an aqueous curable binder system will also contain a crosslinking agent. The crosslinking agent may be any compound suitable for reacting with the carbohydrate, preferably to form a crosslinked polymer network. In exemplary embodiments, the crosslinking agent has a number average molecular weight greater than 90, from about 90 to about 10,000, or from about 190 to about 4.000. In some exemplary embodiments, the crosslinking agent has a number average molecular weight less than about 1000.

Non-limiting examples of suitable crosslinking agents include polycarboxylic acids (and salts thereof), anhydrides, monomeric and polymeric polycarboxylic acid with anhydride (i.e., mixed anhydrides), citric acid (and salts thereof, such as ammonium citrate), 1,2,3,4-butane tetracarboxylic acid, adipic acid (and salts thereof), polyacrylic acid (and salts thereof), and polyacrylic acid based resins such as QXRP 1734 and Acumer 9932, both commercially available from The Dow Chemical Company. In exemplary embodiments, the crosslinking agent may be any monomeric or polymeric polycarboxylic acid, citric acid, and their corresponding salts. In some embodiments, the crosslinking agent preferably comprises polyacrylic acid, citric acid and/or either of their salts. Typically, the crosslinking agent may be present in the aqueous curable binder composition in an amount up to about 40% by weight of solids in the aqueous curable binder composition. In exemplary embodiments, the crosslinking agent may be present in the aqueous curable binder composition in an amount from about 5.0% to about 40% by weight of the total solids in the binder composition, from about 10% to about 40% by weight, or from about 20% to about 35% by weight.

Additional cross-linking agent that may be utilized include the cross-linking agents described in U.S. Pat. No. 11,136,451 B2 granted Oct. 5, 2021 to Zhang et al. entitled “Aqueous Binder Composition” (that are used together with carbohydrates, such as described herein and in some preferred aspects are used together with carbohydrates, such as the polyols described in Zhang et al.

### C) Additional Optional Components of an Aqueous Curable Binder System

If necessary, the pH of the mixture may be adjusted to the desired pH level with organic and inorganic acids and bases.

The aqueous curable binder composition may also contain a coupling agent. Typically, the coupling agent comprises a silane. Table 2 sets forth the typical weight percent of the components of the binder composition when a silane couple agent is included.

TABLE 2

| | % By Weight |
|---|---|
| Component | of Total Solids |
| Carbohydrate | 30-95 |
| Silane Coupling Agent | 1-40 |
| Crosslinking Agent | 1-40 |

Typically, the coupling agent is a silane coupling agent. The coupling agent(s) may be present in the aqueous curable binder composition in an amount typically from about 0.01% to about 5.0% by weight of the total solids in the binder composition, from about 0.01% to about 2.5% by weight, or from about 0.1% to about 0.5% by weight. Non-limiting examples of silane coupling agents that may be used in the binder composition may be characterized by the functional groups alkyl, aryl, amino, epoxy, vinyl, methacryloxy, ureido, isocyanato, and mercapto. In exemplary embodiments, the silane coupling agent(s) include silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., 3-aminopropyl-triethoxysilane and 3-aminopropyl-trihydroxysilane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxysilane and 3-methacryloxypropyltriethoxysilane), hydrocarbon trialkoxysilanes, amino trihydroxysilanes, epoxy trihydroxysilanes, methacryl trihydroxy silanes, and/or hydrocarbon trihydroxvsilanes. In one or more exemplary embodiment, the silane is an aminosilane, such as 7-aminopropyltriethoxysilane.

Further exemplary coupling agents (including silane coupling agents) suitable for use in the binder composition are set forth below:
Acryl: 3-acryloxypropyltrimethoxysilane; 3-acryloxypropyltriethoxysilane; 3-acryloxypropylmethyldimethoxysilane; 3-acryloxypropylmethyldiethoxysilane; 3-methacryloxypropyltrimethoxysilane; 3-methacryloxypropyltriethoxysilane
Amino: aminopropylmethyldimethoxysilane; aminopropyltriethoxysilane; aminopropyltrimethoxysilane/EtOH; aminopropyltrimethoxysilane; N-(2-aminoethyl)-3-aminopropyltrimethoxysilane; N-(2-aminoethyl)-3-aminopropylmethyldimethoxysilane; (2-aminoethyl)-(2-aminoethyl) 3-aminopropyltrimethoxysilane; N-phenylaminopropyltrimethoxysilane
Epoxy: 3-Glycidoxypropylmethyldiethoxysilane; 3-glycidoxypropylmethyldimethoxysilane: 3-glycidoxypropyltriethoxysilane; 2-(3,4-eoxycyclohexyl)ethylmethyldimethoxvsilane; 2-(3,4-epoxycyclohexyl)ethylmethyldiethoxysilane; 2-(3,4-epoxycyclohexyl)ethyltrimethoxysilane; 2-(3,4-Epoxycyclohexyl)ethyltriethoxysilane
Mercapto: 3-mercaptopropyltrimethoxysilane; 3-Mercaptopropyltriethoxysilane; 3-mercaptopropylmethyldimethoxysilane; 3-Mercaptopropylmethyldiethoxysilane
Sulfide: bis[3-(triethoxysilyl)propyl]-tetrasulfide; bis[3-(triethoxysilyl)propyl]-disulfide
Vinyl: vinyltrimethoxysilane; vinyltriethoxysilane; vinyl tris(2-methoxyethoxy)silane; vinyltrichlorosilane; trimethylvinylsilane
Alkyl: methyltrimethoxysilane; methyltriethoxysilane; dimethyldimethoxysilane; dimethyldiethoxysilane; tetramethoxysilane; tetraethoxysilane; ethyltriethoxysilane; n-propyltrimethoxysilane; n-propyltriethoxysilane; isobutyltrimethoxysilane; hexyltrimethoxysilane; hexyltriethoxysilane; octyltrimethoxysilane; decyltrimethoxysilane; decyltriethoxysilane; octyltriethoxysilane; tert-butyldimethylchlorosilane; cyclohexylmethyldimethoxysilane: dicylohexyldimethoxysilane; cyclohexylethyldimethoxysilane; t-butylmethyldimethoxysilane
Chloroalkyl: 3-chloropropyltriethoxysilane; 3-chloropropyltrimethoxysilane; 3-chloropropylmethyldimethoxysilane
Perfluoro: decafluoro-1,1,2,2-tetrahydrodecyl)trimethoxysilane; ((heptadecafluoro-1,1,2,2-tetrahydrodecyl)trimethoxysilane
Phenyl: phenyltrimethoxysilane; phenyltriethoxysilane; diphenyldiethoxysilane; diphenyldimethoxysilane; diphenyldichlorosilane
Hydrolyzates of the silanes listed above
Zirconates: zirconium acetylacetonate; zirconium methacrylate
Titanates: tetra-methyl titanate; tetra-ethyl titanate; tetra-n-propyl titanate; tetra-isopropyl titanate; tetra-isobutyl titanate; tetra-sec-butyl titanate; tetra-tert-butyl titanate; mono n-butyl, trimethyl titanate; mono ethyl tricyclohexyl titanate; tetra-n-amyl titanate; tetra-n-hexyl titanate; tetra-cyclopentyl titanate; tetra-cyclohexyl titanate; tetra-n-decyl titanate; tetra n-dodecyl titanate; tetra (2-ethyl hexyl) titanate; tetra octylene glycol titanate ester; tetrapropylene glycol titanate ester; tetra benzyl titanate; tetra-p-chloro benzyl titanate; tetra 2-chloroethyl titanate; tetra 2-bromoethyl titanate; tetra 2-methoxyethyl titanate; tetra 2-ethoxyethyl titanate.

If desired, a cure accelerator (i.e., catalyst) may optionally be added to the aqueous curable binder composition. The catalyst is used to assist the reaction between the crosslinking agent and carbohydrate. The catalyst may include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Lewis bases (i.e., polyethyleneimine, diethylamine, or triethylamine). Additionally, the catalyst may include an alkali metal salt of a phosphorous-containing organic acid; in particular, alkali metal salts of phosphorus acid, hypophosphorus acid, or polyphosphoric acids. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexamethaphosphate, potassium phosphate, potassium tripolyphosphate, sodium trimetaphosphate, sodium tetramethaphosphate, and mixtures thereof. In addition, the catalyst or cure accelerator may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Other sodium salts such as, sodium sulfate, sodium nitrate, sodium carbonate may also or alternatively be used as the catalyst/accelerator. Additionally, citric acid that has been partially neutralized with a Group I metal base, such as sodium hydroxide, or which has been reacted with trisodium citrate may be utilized as a cure accelerator. The catalyst or cure accelerator may be present in the binder composition in an amount from about 0% to about 10% by weight of the total solids in the binder composition, from about 1.0% to about 5.0% by weight, or from about 3.0% to about 5.0% by weight.

Table 3 provides typical weight ratios of the components of the aqueous curable binder compositions when a silane coupling agent and a catalyst are utilized. These components are all dissolved in water. Typically, the ratios of solids to water range from 1:100 to 50:100.

TABLE 3

| | % By Weight |
|---|---|
| Component | of Total Solids |
| Carbohydrate | 30-95 |
| Silane Coupling Agent | 1-40 |
| Crosslinking Agent | 1-40 |
| Catalyst/accelerator | 1-10 |

The aqueous curable binder composition may also include organic and/or inorganic acids and bases in an amount sufficient to adjust the pH to a desired level. The pH may be adjusted depending on the intended application, or to facilitate the compatibility of the ingredients of the binder composition. In exemplary embodiments, the pH adjuster is utilized to adjust the pH of the binder composition to an acidic pH. Examples of suitable acidic pH adjusters include inorganic acids such as, but not limited to sulfuric acid, phosphoric acid and boric acid and also organic acids like mono- or poly-carboxylic acids, such as, but not limited to, citric acid, acetic acid, anhydrides thereof, and their corresponding salts. Also, inorganic salts that can be acid precursors may be utilized. The acid adjusts the pH, and in some instances, as discussed above, acts as a crosslinking agent. The pH of the curable binder typically ranges from about 1 to about 7, from about 2 to about 5, or from about 2 to about 4. In at least one exemplary embodiment, the pH of the aqueous curable binder composition is from about 2.6 to about 3.5.

Further, the aqueous curable binder composition may contain a moisture resistant agent, such as alum, aluminum sulfate, latex, a silicon emulsion, reactive silicone emulsion, a hydrophobic polymer emulsion (e.g., polyethylene emulsion or polyester emulsion), and mixtures thereof. In at least one exemplary embodiment, the latex is in the form of an aqueous latex emulsion. The latex emulsion includes latex particles that are typically produced by emulsion polymerization. In addition to the latex particles, the latex emulsion may include water, a stabilizer such as ammonia, and a surfactant. The moisture resistant agent may be present in the binder composition in an amount from about 0% to about 20% by weight of the total solids in the binder composition, from about 5.0% to about 10% by weight, or from about 5.0% to about 7.0% by weight.

The aqueous curable binder composition may optionally contain conventional additives such as, but not limited to corrosion inhibitors, dyes, pigments, fillers, colorants, UV stabilizers, thermal stabilizers, anti-foaming agents, anti-oxidants, emulsifiers, preservatives (e.g., sodium benzoate), biocides, fungicides, and mixtures thereof. Other additives may be added to the aqueous curable binder composition for the improvement of process and product performance. Such additives include lubricants, wetting agents, surfactants, antistatic agents, and/or water repellent agents. Additives may be present in the binder composition from trace amounts (such as <about 0.1% by weight the binder composition) up to about 10.0% by weight of the total solids in the aqueous curable binder composition. In some exemplary embodiments, the additives are present in an amount from about 0.1% to about 5.0% by weight of the total solids in the aqueous curable binder composition, from about 1.0% to about 4.0% by weight, or from about 1.5% to about 3.0% by weight.

### Dedust Composition

The dedust composition comprises ESO having a high flash point that will help minimize the chances of flash fires and/or explosions in high temperature environments and will also degrade slower than petroleum based mineral oils having lower flash points. Typically, ESO has a flash point of at least 280° C., preferably at least 290° C., and more preferably at least 295° C., and in some instances at least 300° C. The ESO typically has a viscosity at 40° C. of from 120 to 250 cSt, preferably from 150 to 200 cSt, more preferably from 170 to 190 cSt, and in some instances from 175 to 185 cSt at 40° C. The ESO typically has a viscosity at 25° C. of from 200 to 600 cSt, preferably from 250 to 550 cSt. and more preferably from 300 to 500 cSt at 25° C. The high flash point and relatively high viscosity provide for dedust composition that can withstand the high temperatures utilized to cure the binder composition and fiberglass. Typically, the ESO has a pour point of less than 25° C., less than 20° C., 10° C. or less (for example from about 0° C. to about 10° C.).

The ESO typically has a moisture content of less than 1.0 wt %, preferably less than 0.5 wt %, and more preferably less than 0.1 wt %.

The ESO typically has an acid value (AV) of less than 1 mg KOH/g, preferably less than 0.5 mg KOH/g, and in some instances more preferably less than 0.1 mg KOH/g. A low AV will ensure the ESO has a sufficiently high flash point as described herein.

The ESO typically has an iodine value of less than 10 cg I₂/gram, preferably less than 5 cg I₂/gram, and more preferably less than 3 cg I₂/gram. This low iodine value will minimize any oxidation reactions that can take place with the dedust oil during the manufacture of the fibrous insulation product. This is exemplified by a low oxidation exotherm measured by pressure differential scanning calorimeter with an oven temperature of 130° C. and oxygen inlet pressure of 500 PSIG (as described in the Examples) of less than 500 joules/gram, less than 300 joules/gram, less than 250 joules/gram, less than 200 joules/gram, less than 100 joules/gram, less than 50 joules/gram, less than 30 joules/gram, less than 20 joules/gram, less than 10 joules/gram, and sometimes less than 5 joules/gram (for example, less than 3 joules/gram as measured pressure differential scanning calorimeter with an oven temperature of 130° C. and oxygen inlet pressure of 500 PSIG.

The ESO typically has an oxirane content of at least 4.5 wt %, and preferably an oxirane content of at least 5.5 wt %, more preferably at least 6 wt %, and most preferably at least 6.5 wt %.

The dedust composition is applied to the fibers to reduce the amount of dust that is generated during the manufacture of the fibrous insulation product.

The dedust composition may be applied as a neat oil to the fibers or the dedust composition may be applied in the form of an oil in water emulsion comprising the ESO. The dedust composition typically is applied concurrently to the fibers with the binder composition, such as an aqueous curable binder system described above.

If the dedust composition is in the form of an oil in water emulsion, then preferably at least one emulsifying component is utilized to form the oil in water emulsion. The emulsion typically is typically formed by vigorously agitating the water and the oil in the presence of the at least one emulsifying component. Examples of apparatus that can be utilized to effectively used to form the oil in water emulsion include high shear mechanical devices/mixers, ultrasonic devices, and other equipment/devices known to those of skill in the art for use in forming oil in water emulsions. The weight ratio of the at least one emulsifying components to ESO is from 1:200 to 15:100, for example from 1:200 to 5:100, from 1:200 to 3:100 by weight.

Typically, excluding the weight of any water present in the dedust composition, the dedust composition is present in a cured insulation product, such as fiberglass insulation product of the invention at a weight percent of from about 0.1 to about 5% by weight of mineral fiber, such as glass present (for example, from about 0.5 to about 4.0%, or from about 0.5% to about 3.0% by weight (and in some instances from 0.6% to 1.5% by weight) of the mineral fiber (glass) present). Excluding the weight of water, the weight ratio of the dedust composition to the solids of the binder composition (such as an aqueous curable binder system) typically is from about 1/100 to 34/100, for example from about 6/100 to 13/100, from about 4/100 to 10/100.

In one aspect the at least one emulsifying component comprises a single emulsifier that is utilized to form the emulsion. In this aspect, the emulsifier typically is mixed into the ESO before water is introduced to form the emulsion. Examples of emulsifiers that can be utilized include, for example, ionic emulsifiers, non-ionic emulsifiers and mixtures thereof. To minimize competing reactions between the emulsifier and the components of the aqueous curable binder composition, non-ionic emulsifiers preferably are utilized. Examples of non-ionic emulsifiers include: alkoxylated alcohols and alkoxylated fatty acids. Examples of ionic emulsifiers include amine-based emulsifiers (i.e., primary, secondary, tertiary, and quaternary amine-based emulsifiers). Preferably ethoxylated alcohols and ethoxylated fatty acids are utilized. Most preferably, ethoxylated alcohols are utilized.

In another aspect, the at least one emulsifying component comprises a first emulsifying component that is blended into the ESO, and a second emulsifying component that is blended into the water that is utilized to form the oil in water emulsion with the oil. Preferably, in this aspect the first emulsifying component and the second emulsifying component are mixed into the oil and water respectively before the oil and water are mixed together to form the oil in water emulsion. Examples of compounds that may be used for the first emulsifying component include the emulsifiers listed above. Examples of compounds that may be used for the second emulsifying component include: carboxymethylcellulose; maltodextrin; carbohydrates; polyols; natural viscosifiers, such as, xanthan gum, guar gum, schleroglucan; and mixtures thereof. Preferably, the second emulsifying component will increase the viscosity of the water and assist the formation of the oil in water emulsion and enhance the long term stability of the oil in water emulsion. For example, preferably the second emulsifying component will provide an aqueous-based solution having a viscosity of from 15 to 35 centipoise at 25° C., for example from 17 to 33 centipoise at 25° C., preferably from 18 to 25 centipoise at 25° C. for an aqueous solution containing less than 1 percent by weight of the second emulsifying component, preferably less than 0.5 percent by weight (for example less than 0.3 percent by weight) of the second emulsifying component. For stability, in some aspects, the oil in water emulsion will be stable for at least 4 hours, more preferably at least 14 hours and in some instances at least 24 hours (for example, at least 48 hours, 72, hours, 96, hours, or 120 hours. Where long term stability is particularly important, the oil in water emulsion will be stable for at least one week, and in some instances at least two weeks (for example, at least three weeks). Preferably the second emulsifying component comprises carboxymethylcellulose.

The ESO typically is made using formic acid or acetic acid (or other suitable organic acids, such as fatty acids) are used together with hydrogen peroxide to epoxidize the soybean oil. The formic acid or acetic acid reacts with a peroxide to form a peracid (i.e., performic and/or peracetic acid. The peracid then reacts with unsaturated carbon-carbon bond in the soybean oil to form oxirane groups. The organic acid is liberated from the reaction of the peracid with the soybean oil and is typically recycled for reuse. In some aspects, formic acid typically is used instead of acetic acid to form the peracid, due to a strong mineral acid often being necessary to form a peracid when acetic acid is used. However, acetic acid typically is used to form a peracid when recycling the acetic acid is desired.

### Fibrous Insulation Products

In one exemplary embodiment, the binder composition is used to form a fibrous insulation product. Fibrous insulation products are generally formed of matted inorganic fibers bonded together by a cured thermoset polymeric material. Examples of suitable inorganic fibers include glass fibers, wool glass fibers, stone wool fibers, and ceramic fibers. Optionally, other reinforcing fibers such as natural fibers and/or synthetic fibers such as polyester, polyethylene, polyethylene terephthalate, polypropylene, polyamide, aramid, and/or polyaramid fibers may be present in the insulation product in addition to the glass fibers. The term “natural fiber” as used in conjunction with the present invention refers to plant fibers extracted from any part of a plant, including, but not limited to, the stem, seeds, leaves, roots, or phloem. Examples of natural fibers suitable for use as the reinforcing fiber material include basalt, cotton, jute, bamboo, ramie, bagasse, hemp, coir, linen, kenaf, sisal, flax, henequen, and combinations thereof. Insulation products may be formed entirely of one type of fiber, or they may be formed of a combination of types of fibers. For example, the insulation product may be formed of combinations of various types of glass fibers or various combinations of different inorganic fibers and/or natural fibers depending on the desired application for the insulation. The embodiments described herein are with reference to insulation products formed entirely of glass fibers.

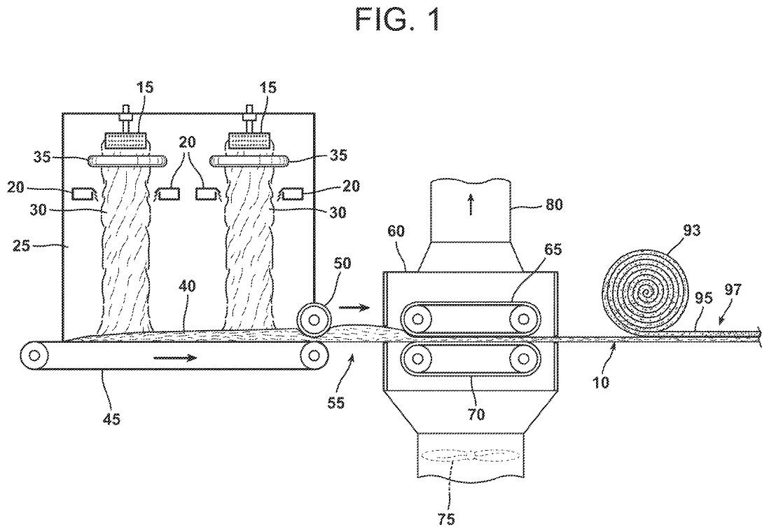

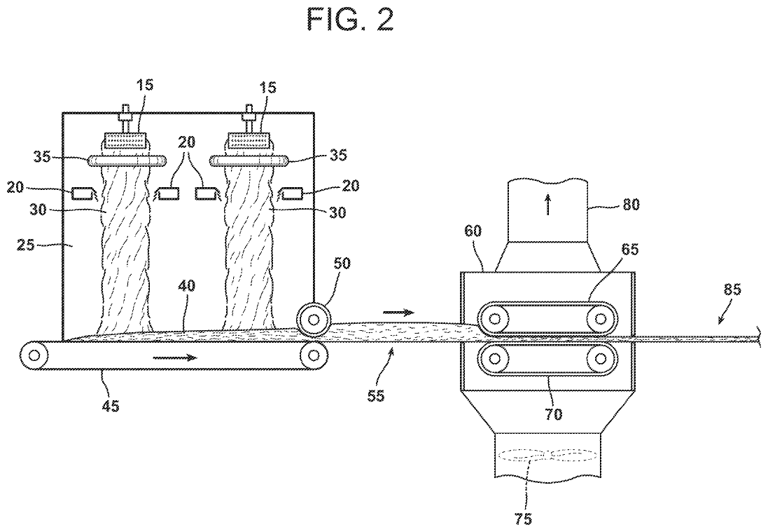

The manufacture of glass fiber insulation may be carried out in a continuous process by fiberizing molten glass, immediately forming a fibrous glass batt on a moving conveyor and curing the binder on the fibrous glass insulation batt to form an insulation blanket as depicted in FIGS. 1 and 2. Glass may be melted in a tank (not shown) and supplied to a fiber forming device such as a fiberizing spinner 15. The spinners 15 are rotated at high speeds. Centrifugal force causes the molten glass to pass through holes in the circumferential sidewalls of the fiberizing spinners 15 to form glass fibers. Glass fibers 30 of random lengths may be attenuated from the fiberizing spinners 15 and blown generally downwardly, that is, generally perpendicular to the plane of the spinners 15, by blowers 20 positioned within a forming chamber 25. It is to be appreciated that the glass fibers 30 may be the same type of glass or they may be formed of different types of glass. It is also within the purview of the present invention that at least one of the fibers 30 formed from the fiberizing spinners 15 is a dual glass fiber where each individual fiber is formed of two different glass compositions.

The blowers 20 turn the fibers 30 downward to form a fibrous batt 40. The glass fibers 30 may have a diameter from about 2 to about 9 microns, or from about 3 to about 6 microns. The small diameter of the glass fibers 30 helps to give the final insulation product a soft feel and flexibility.

The glass fibers, while in transit in the forming chamber 25 and while still hot from the drawing operation, are sprayed with the binder composition and dedust composition. The dedust composition may be in the form of an emulsion and is mixed with the aqueous curable binder composition before being sprayed onto the glass fibers through an annular spray ring 35 so as to result in a distribution of the binder composition throughout the formed insulation pack 40 of fibrous glass. Alternatively, the dedust composition may be applied to the fibers separately from the aqueous curable binder composition through another spray ring. Water may also be applied to the glass fibers 30 in the forming chamber 25, such as by spraying, prior to the application of the aqueous curable binder composition to at least partially cool the glass fibers 30. The binder composition typically is present in an amount from less than or equal to 30% by weight of the total product. The dedust composition typically is present in an amount from 0.1 to 5.0 percent by weight of the total product.

The glass fibers 30 having the uncured binder composition) adhered thereto may be gathered and formed into an uncured insulation pack 40 on an endless forming conveyor 45 within the forming chamber 25 with the aid of a vacuum (not shown) drawn through the fibrous pack 40 from below the forming conveyor 45. The residual heat from the glass fibers 30 and the flow of air through the fibrous pack 40 during the forming operation are generally sufficient to volatilize a majority of the water from the binder before the glass fibers 30 exit the forming chamber 25, thereby leaving the remaining components of the binder on the fibers 30 as a viscous or semi-viscous high-solids liquid.

The coated fibrous pack 40, which is in a compressed state due to the flow of air through the pack 40 in the forming chamber 25, is then transferred out of the forming chamber 25 under exit roller 50 to a transfer zone 55 where the pack 40 vertically expands due to the resiliency of the glass fibers. The expanded insulation pack 40 is then heated, such as by conveying the pack 40 through a curing oven 60 where heated air is blown through the insulation pack 40 to evaporate any remaining water in the binder, cure the binder, and rigidly bond the fibers together. Heated air is forced though a fan 75 through the lower oven conveyor 70, the insulation pack 40, the upper oven conveyor 65, and out of the curing oven 60 through an exhaust apparatus 80. The cured binder imparts strength and resiliency to the insulation blanket 10. It is to be appreciated that the drying and curing of the binder may be carried out in either one or two different steps. The two stage (two-step) process is commonly known as B-staging.

Also, in the curing oven 60, the insulation pack 40 may be compressed by upper and lower foraminous oven conveyors 65, 70 to form a fibrous insulation blanket 10. It is to be appreciated that the insulation blanket 10 has an upper surface and a lower surface. In particular, the insulation blanket 10 has two major surfaces, typically a top and bottom surface, and two minor or side surfaces with fiber blanket 10 oriented so that the major surfaces have a substantially horizontal orientation. The upper and lower oven conveyors 65, 70 may be used to compress the insulation pack 40 to give the insulation blanket 10 a predetermined thickness. It is to be appreciated that although FIG. 1 depicts the conveyors 65, 70 as being in a substantially parallel orientation, they may alternatively be positioned at an angle relative to each other (not illustrated).

The curing oven 60 may be operated at a temperature from about 100° C. to about 400° C., or from 150° C. to 325° C., or from about 250° C. to about 300° C. The insulation pack 40 may remain within the oven for a period of time sufficient to crosslink (cure) the binder and form the insulation blanket 10.

A facing material 93 may then be placed on the insulation blanket 10 to form a facing layer 95. Non-limiting examples of suitable facing materials 93 include Kraft paper, a foil-scrim-Kraft paper laminate, recycled paper, and calendared paper. The facing material 93 may be adhered to the surface of the insulation blanket 10 by a bonding agent (not shown) to form a faced insulation product 97. Suitable bonding agents include adhesives, polymeric resins, asphalt, and bituminous materials that can be coated or otherwise applied to the facing material 93. The faced fibrous insulation 97 may subsequently be rolled for storage and/or shipment or cut into predetermined lengths by a cutting device (not illustrated). Such faced insulation products may be used, for example, as panels in basement finishing systems, as ductwrap, ductboard, as faced residential insulation, and as pipe insulation. It is to be appreciated that, in some exemplary embodiments, the insulation blanket 10 that emerges from the oven 60 is rolled onto a take-up roll or cut into sections having a desired length and is not faced with a facing material 93. Optionally, the insulation blanket 10 may be slit into layers and by a slitting device and then cut to a desired length (not illustrated).

A significant portion of the insulation placed in the insulation cavities of buildings is in the form of insulation blankets rolled from insulation products such as is described above. Faced insulation products are installed with the facing placed flat on the edge of the insulation cavity, typically on the interior side of the insulation cavity. Insulation products where the facing is a vapor retarder are commonly used to insulate wall, floor, or ceiling cavities that separate a warm interior space from a cold exterior space. The vapor retarder is placed on one side of the insulation product to retard or prohibit the movement of water vapor through the insulation product.

The presence of water, dust, and/or other microbial nutrients in the insulation product 10 may support the growth and proliferation of microbial organisms. Bacterial and/or mold growth in the insulation product may cause odor, discoloration, and deterioration of the insulation product 10, such as, for example, deterioration of the vapor barrier properties of the Kraft paper facing. To inhibit the growth of unwanted microorganisms such as bacteria, fungi, and/or mold in the insulation product 10, the insulation pack 40 may be treated with one or more anti-microbial agents, fungicides, and/or biocides. The anti-microbial agents, fungicides, and/or biocides may be added during manufacture or in a post manufacture process of the insulation product 10. It is to be appreciated that the insulation product made using the method may be a fiberglass batt as depicted, or as loosefill insulation, ductboard, ductliner, or pipe wrap (not depicted in the Figures).

The use of a dedust fluid/composition comprising ESO as described above reduces the risk of fire, explosions, and oxidation that may occur during the manufacture of the fibrous insulation product compared to similar risks present during the manufacture of fibrous insulation products using dedusting agents not comprised of ESO.

Having generally described this invention, a further understanding can be obtained by reference to certain specific examples illustrated below which are provided for purposes of illustration only and are not intended to be all inclusive or limiting unless otherwise specified.

### EXAMPLES

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

### Example 1-1: Method of Making Epoxidized Soybean Oil One (ESO 1)

376 g of Refined Bleached and Deodorized (RBD) Soybean oil, 30.5 g of glacial acetic acid, and 3 g of 98% sulfuric acid were added to a 1 liter, 4 neck, jacketed reactor with a mechanical stirrer. The reactor was heated to 66° C. using a temperature-controlled water bath. Once the reactor was at 66° C., 194 g of 50% hydrogen peroxide were slowly added over 3 hours using an addition funnel. The bath temperature was altered throughout the reaction in order to maintain 66° C. in the reactor. Once the hydrogen peroxide addition was complete, the reactor was sampled hourly for iodine value of the organic phase. Once the iodine value was <3 cg I₂/g, the reactor was cooled to 40° C. At 40° C. the agitation was stopped, and the aqueous and organic phases were allowed to separate. When the phases separated the bottom aqueous layer was decant off. The top organic layer was then washed 2 times with 220 g of water and allowed to separate. The organic layer was then transferred to a 1 liter, 4 neck, round bottom flask, 0.9 g of calcium hydroxide were added to the flask and the flask was heated to 110° C. with a mechanical agitator and nitrogen sparge. Once the flask was at 110° C., 50 torr of vacuum was applied and 25 g of water were added, over 2 hours, through a sparge needle in order to steam strip the product. The product was then allowed to dry at 110° C. and 50 torr vacuum for 30 minutes. After 30 minutes, vacuum was broken, and the product was cooled to 70° C. before filtering through a celite coated Buchner funnel. The resulting epoxidized soybean oil had an acid value of 0.05 mg KOH/g, iodine value of 2.4 cg b/g, epoxy oxygen content of 6.95%, a viscosity of 182 cst at 40° C., and a pour point of 5° C.

### Example 1-2: Method of Making Epoxidized Soybean Oil Two (ESO 2)

892 g of RBD Soybean oil and 55.4 g of 88% formic acid were added to a 2 liter, 4 neck, jacketed reactor with a mechanical stirrer. The reactor was heated to 66° C. using a temperature-controlled water bath. Once the reactor at 66° C., 450 g of 50% hydrogen peroxide were slowly added over 2 hours using an addition funnel. The bath temperature was altered throughout the reaction in order to maintain 66° C. in the reactor. Once the hydrogen peroxide addition was complete, the reactor was sampled hourly for iodine value of the organic phase until the iodine value was <3 cg I₂/g. Once the iodine value was <3 cg I₂/g, the reactor was cooled to 40° C. At 40° C. the agitation was stopped, and the aqueous and organic phases were allowed to separate. When the phases separated the bottom aqueous layer was decant off. The top organic layer was then washed 3 times with 220 g of water and allowed to separate. The organic layer was then transferred to a 2-liter, 4 neck, round bottom flask and heated to 110° C. with mechanical agitation and a nitrogen sparge. Once the flask was at 110° C. 50 torr of vacuum was applied and 50 g of water were added, over 2 hours, through a sparge needle in order to steam strip the product. The product was then allowed to dry at 110° C. and 50 torr vacuum for 30 minutes. After 30 minutes, vacuum was broken, and the product was cooled to 70° C. before filtering through a celite coated Buchner funnel. The resulting epoxidized soybean oil had an acid value of 0.5 mg KOH/g, iodine value of 2.9 cg I₂/g, epoxy oxygen content of 6.87%, a viscosity of 178 cst at 40° C., and a pour point of 4° C.

ESO 1 and ESO 2 were tested for Acid Value, Iodine Value, Viscosity, Oxirane content, Pour Point, and Open Cup Flash Point as described above.

The oxidation exotherms of fiberglass coated with 0.5 wt % ESO 1 and ESO 2 are measured as follows:

About 10 to 20 milligrams of ESO 1 and ESO 2 are loaded on a testing pan, is inserted into a testing cylinder. The testing cylinder is closed and inserted into a pressure differential scanning calorimeter having model number DSC25P available from TA Instruments in order to measure the oxidation exotherms exhibited by ESO 1 and ESO 2. The calorimeter heats the ESO samples from 40° C. to 130° C. in about a minute. Once the temperature reaches about 130° C., the sample cell/cylinder is pressurized with 500 PSIG oxygen. The sample is held at this temperature and pressure for about 5 hours. The calorimeter measures and outputs to a digital computer the total energy released (i.e., the exothermic reaction) during the evaluation of the samples, which occurs as a result of oxidation of the sample. The data output is analyzed using TA Instruments Trios software to calculate the enthalpy oxidation energy released by the sample in Joules/gram of sample tested.

The results of the analysis are set forth below in Table 4.

TABLE 4

| | Acid | | | | | Open Cup | |
|---|---|---|---|---|---|---|---|
| | Value | Iodine | Viscosity | Oxirane | Pour | Flash | Oxidation |
| | (mg | Value | at 40° C. | content | Point | Point | Exotherm |
| | KOH/g) | (cg I₂/g) | (cSt) | (%) | (° C.) | (° C.) | (joules/gram) |
| Example | 0.05 | 2.4 | 182 | 6.95 | 5° | >290° C. | None |
| 1-1 | | | | | | | detected |
| Example | 0.5 | 2.9 | 178 | 6.87 | 4° | 297° C. | None |
| 1-2 | | | | | | | detected |

As can be seen from Table 4, ESO 1 and ESO 2 have very high open cup flash point, and exhibit low oxidation exotherms. Also, as can be seen from Table 4, both ESO 1 and ESO 2 have pour points between 0° C. and 10° C., so they both will remain liquid at room temperature. They therefore will provide excellent de-dusting characteristics during storage, shipping and handling of insulation products that they are used to manufacture.

### Example 2: Making Fiberglass Insulation

One set of R-19 to R-20 fiberglass insulation batts are manufactured in a conventional manner known to one of ordinary skill in the art. All the fiberglass batts are manufactured with a target LOI of 6.0+0.5.

The set of batts are manufactured utilizing an aqueous curable binder system. ESO 2 is utilized for the dedust composition. The amount of dedust composition utilized in the manufacture of this set of fiberglass batts varies from 0.375 to 0.75 percent by weight based on the weight of the cured fiberglass insulation. Additionally, about thirteen percent (13%) by weight of a gamma-aminopropyl-trihydroxy-silane coupling agent and five percent (5%) by weight of Sodium Hypophosphite accelerant based on the weight of the binder composition, silane, and accelerant are utilized during the manufacture of the fiberglass batts. The extent of curing (high, medium, and low cure) is varied during the manufacture of the fiberglass batts of this first set.

All bats are made without the occurrence of any fire, explosion or runaway oxidation event. All the bats have excellent physical properties and are consistent throughout.

1. A method for making a fibrous insulation product, the method comprising:
forming a plurality of randomly oriented mineral fibers;
applying a binder composition to the mineral fibers to form a fibrous insulation blanket;
applying a dedust composition comprising epoxidized soybean oil to the mineral fibers or the fibrous insulation blanket; and
heating the fibrous insulation blanket to form the fibrous insulation product, wherein the epoxidized soybean oil has (i) a viscosity of from 120 to 250 cSt at 40° C., (ii) an AV of less than 1 mg KOH/g, (iii) a Cleveland Open Cup Flash point of at least 280° C., (iv) an iodine value of less than 10 cg I₂ per gram, (v) an oxirane content of at least 4.5 wt %, and (vi) an oxidation exotherm by pressure differential scanning calorimeter of less than 500 joules/gram at an oven temperature of 130° C. and an oxygen inlet pressure of 500 PSIG.

2. The method of claim 1, wherein the viscosity of the epoxidized soybean oil is from 150 to 200 cSt at 40° C. or from 170 to 190 cSt at 40° C.

3. (canceled)

4. The method of claim 1, wherein the AV of the epoxidized soybean oil is less than 0.5 KOH/g or less thian 0.1 KOH/g.

5. (canceled)

6. The method of claim 1, wherein the Cleveland Open Cup Flash point of the epoxidized soybean oil is at least 290° C. or at least 295° C.

7. (canceled)

8. The method of claim 1, the iodine value of wherein the epoxidized soybean oil is less than 5 cg I₂ per gram or less than 3 cg I₂ per gram.

9. (canceled)

10. The method of claim 1, wherein oxirane content of the epoxidized soybean oil is at least 5.5 wt % or at least 6.0 wt %.

11. (canceled)

12. The method of claim 1, wherein the epoxidized soybean oil has an oxidation exotherm by pressure differential scanning calorimeter of less than 300 joules/gram at an oven temperature of 130° C. and an oxygen inlet pressure of 500 PSIG.

13. (canceled)

14. The method of claim 1, wherein the heating step comprises:
passing the fibrous insulation blanket through an oven to cure the binder composition.

15. The method of claim 1, wherein the binder composition comprises an aqueous curable binder.

16. The method of claim 1, wherein the binder composition comprises an aqueous curable binder comprising:
(i) at least one carbohydrate; and
(ii) at least one crosslinking agent.

17. (canceled)

18. The method of claim 1, wherein the dedust composition comprises at least one emulsifying component, an aqueous fraction, and an organic fraction; wherein the at least one emulsifying component is selected from the group consisting of non-ionic emulsifiers, ionic emulsifiers, and mixtures thereof.

19. (canceled)

20. The method of claim 1, wherein the dedust composition is an oil in water emulsion and comprises a first emulsifying component and a second emulsifying component; wherein the first emulsifier component is mixed into the epoxidized soybean oil before the oil in water emulsion is formed.

21. The method of claim 20, wherein the second emulsifying component is mixed into an aqueous solution before the oil-water emulsion is formed by mixing the aqueous solution and the epoxidized soybean oil; and the second emulsifying component is selected from the group consisting of carbohydrates, maltodextrin, carboxymethyl cellulose, polyols, and mixtures thereof.

22. (canceled)

23. (canceled)

24. The method of claim 16, wherein the at least one carbohydrate comprises carbohydrates selected from the group consisting of glucose syrup, fructose syrup, dextrose, corn syrup, pectin, dextrin, maltodextrin, starch, modified starch, starch derivatives, and combinations thereof.

25. (canceled)

26. The method of claim 16, wherein the crosslinking agent is selected from the group consisting of polycarboxylic acids, salts of polycarboxylic acid, anhydrides, monomeric carboxylic acid with anhydride, polycarboxylic acid with anhydride, salts of citric acid, adipic acid, salts of adipic acid, polyacrylic acid, salts of polyacrylic acid, polyacrylic acid-based resins, and combinations thereof.

27. The method of any of claim 16, wherein the binder composition additionally comprises at least one of: at least one coupling agent; a moisture resistant agent, a catalyst, an inorganic acid, an inorganic base, an organic base, and combinations thereof.

28. The method of claim 1, wherein the weight ratio of binder composition to dedust composition is from about 100:1 to 100:34.

29. The method of claim 1, wherein the fiberglass insulation product comprises a cured binder composition comprises at least one polyester.

30. The method of claim 1, wherein the fiberglass insulation product is free of added formaldehyde.

31. (canceled)

32. The method of claim 1, wherein the mineral fiber comprises glass fibers, fibers made from stone, and mixtures thereof, and the fibrous insulation product comprises a fiberglass insulation product.

33. A fibrous insulation product made according to the methods of claim 1.

34. (canceled)

35. A dedust composition for dedusting a fibrous insulation product comprising an epoxidized vegetable oil, wherein the epoxidized vegetable oil has an iodine value less than 10 cg I₂ per gram, an oxidation exotherm by pressure differential scanning calorimeter of less than 500 joules/gram at an oven temperature of 130° C., and an oxygen inlet pressure of 500 PSIG.

36. The dedust composition of claim 35, wherein the iodine value of the epoxidized vegetable oil is less than 5 cg I₂ per gram or less than 3 cg I₂ per gram.

37. (canceled)

38. (canceled)

39. The dedust composition of claim 35, wherein the epoxidized vegetable oil has an oxidation exotherm by pressure differential scanning calorimeter of less than 300 joules/gram at an oven temperature of 130° C. and an oxygen inlet pressure of 500 PSIG.

40. (canceled)

41. The method of claim 1, wherein the epoxidized soybean oil has a pour point of less than 25° C. or less than 10° C.

42. (canceled)
